(19) United States
(12) Patent Application Publication
(10) Pub. No.: US 2009/0327154 A1
(43) Pub. Date: Dec. 31, 2009

(54) SYSTEMS, METHODS, AND COMPUTER PROGRAM PRODUCTS FOR MONITORING COLLATERALIZATION OF PUBLIC-DEPOSIT ACCOUNTS

(75) Inventors: Daniel A. Van Vooren, Charlotte, NC (US); Judith A. Breault, Charlotte, NC (US); Linda Grant, Weddington, NC (US); Barry Edward Hagan, Fort Mill, SC (US); Stephan R. Hudson, Charlotte, NC (US); Kishore Pasumarthi, Charlotte, NC (US); Sudhir C. Patel, Charlotte, NC (US); Pamela Reed, Charlotte, NC (US); Alpesh R. Shah, Charlotte, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: Bank of America Corporation, Charlotte, NC (US)

(21) Appl. No.: 12/112,763

(22) Filed: Apr. 30, 2008

(51) Int. Cl. G06Q 40/00; G06F 15/16

(52) U.S. Cl. 705/36 R; 709/204; 705/35; 705/37

(57) ABSTRACT

The present invention provides systems, methods, and computer program products for monitoring collateral positions of public-deposit accounts so as to efficiently pledge collateral to under-collateralized positions and release collateral from over-collateralized positions. For example, when a customer deposits additional funds, which results in an uninsured balance that exceeds the allocated collateral, the present invention may identify that account as being under-collateralized, determine the pledge amount required to properly collateralize the account, and then create, submit and track a pledge request that corresponds to the required pledge amount. Likewise, when a customer withdraws funds from a public-deposit account, which results in an uninsured balance that is less than the allocated collateral, the present invention may identify that account as being over-collateralized, determine the appropriate release amount, and then create, submit and track a release request that corresponds to the determined release amount.

### BACKGROUND OF THE INVENTION

1. Field of the Invention

The present invention relates generally to systems, methods, and computer program products for monitoring collateralization of public-deposit accounts, and more particularly to monitoring collateral positions of public-deposit accounts so as to facilitate the pledge of collateral to under-collateralized positions and release of collateral from over-collateralized positions.

2. Description of the Related Art

Many states have enacted laws to protect public fund deposits that exceed FDIC insurance coverage. Typically, these laws require banks to deliver collateral to a third-party institution to be held in custody for the benefit of the public fund depositor. The nature of the collateral requirements is unique to each state and as a bank expands and takes deposits from public fund depositors in an increasing number of states, the complexity of the bank's collateral pledging system increases as well. State statutes govern the type of assets that are eligible as collateral and the percentage of coverage required. Further, in some instances, a public fund account holder for a public fund account may include added restrictions on the type of assets that are eligible as collateral and the percentage of coverage required. In addition, each state may define penalties that may be imposed on the depository bank if the bank fails to meet collateral requirements. States monitor the bank's performance through required periodic reports, internal and external audits, and by requiring the bank's records to be available for inspection. Public funds placed on deposit from a federal source are subject to U.S. Code and various regulatory agencies. If a bank fails, the public fund depositors will require the third party custodial to deliver the pledged collateral to them for liquidation. The depositor will recover any lost funds through the sale of the collateral. Any excess proceeds from the liquidation of the collateral, would be returned by the public fund depositor to the regulatory agency controlling the failed bank.

To efficiently manage the pledging of collateral to protect public fund deposits, banks must devise systems to gather information from the deposit systems, the collateral allocation system, and the public fund depositor's collateral requirements rule set to make daily comparisons to determine the status of each public fund depositor's collateral position. Public fund deposits are subject to daily balance fluctuations, and the market value of the collateral pledged varies daily as well with market conditions. The collateral monitoring system must be able to properly determine if an additional amount of collateral is required for a public fund depositor or if excess collateral should be requested back from the public fund depositor. The bank must weight the cost of moving the collateral against the opportunity cost of keeping excess collateral pledged against a public fund deposit.

### BRIEF SUMMARY OF THE INVENTION

The systems, methods, and computer program products of the present invention provide various embodiments for tracking and analyzing positions requiring collateralization. The systems, methods, and computer program products determine whether such positions are either under or over collateralized. Based on this analysis, the systems, methods, and computer program products of the present invention provide alerts and may facilitate altering collateralization amounts for the position.

For example, the systems, methods, and computer program products may be used to monitor public fund deposit accounts to determine whether such accounts are properly collateralized based on either one or both state laws or specific rules defined by the public fund account holder for the public fund account. In general, embodiments of the present invention access deposit account data and extract information relating to deposit accounts containing public funds. Various rules are then applied to these accounts to determine which accounts are subject to collateralization rules and any public fund depositor specific rules. Accounts that indicate under collateralization based on these rules are flagged. Further, in some embodiments, accounts that are over collateralized may also be flagged. These accounts are then presented to either a user or system for adjusting collateral positions on the accounts.

In one embodiment, the present invention provides a system for collateralizing a position. The system comprises a processing system capable of analyzing bank data associated with the position to determine whether the position is over/under collateralized. A pledge/release system is in communication with the processing system and configured to generate a pledge/release request if the position is not properly collateralized. The pledge/alert request may be provided to a custodial system to either increase or decrease the collateral position for the account. For example, in some embodiments, a “basket” of various collateral items may be provided to the custodial system. The custodial system may either select collateral from the basket to further collateralize an under collateralized account or place collateral currently associated with the account into the basket for over collateralized accounts. In this manner, the collateralization positions on the account can be maintained at required levels.

In some embodiments, the particular account may have associated rules dictating a specific form of collateral or a “basket” of possible collateral may not include sufficient collateral or the type of collateral needed to collateralize an account. In these instances, the system of the present invention may further include a trading system that receives the pledge/release request in the form of a trading blotter. Based on information in the pledge/release request trading blotter, the trading system may acquire collateral of a required type and/or amount to be pledged to meet the deficiency in an account.

Depending on the particular account to be collateralized various rules and restrictions may apply. Some rules and restrictions are public fund depositor specific. In other cases, such as with public fund accounts, rules and restrictions may be dictated by various government entities. As such, in some embodiments, the present invention includes a set of collateral rules or rules engine that account for these variations in different accounts. These set of rules are used by the systems, methods, and computer program products of the present invention to properly access collateral positions on the accounts and provide for proper collateralization.

In addition to the above described system, the present invention also provides methods and computer program products that implement analysis of deposits and adjusting collateralization thereof similar that described above.

### BRIEF DESCRIPTION OF THE SEVERAL VIEWS OF THE DRAWINGS

FIG. 1 is a system diagram illustrating operational flow at a system level according to one embodiment of the present invention;

FIG. 2 is an operation flow diagram illustrating the collateralization of a position according to one embodiment of the present invention; and

FIG. 3 is a graphic depiction of an interface generated according to one embodiment of the present invention illustrating a collateralization report.

### DETAILED DESCRIPTION OF THE INVENTION

The following detailed description of embodiments refers to the accompanying drawings, which illustrate specific embodiments of the invention. Other embodiments having different structures and operation do not depart from the scope of the present invention.

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-readable medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

In general terms, the present invention provides systems, methods, and computer program products for monitoring positions on accounts, such as public deposit accounts, that require collateralization by an institution providing the account. The systems, methods, and computer program products extract account data and determine which accounts have collateralization requirements. Each of these accounts is analyzed based on various collateralization rules. These collateralization rules, for each account, dictate whether the account is subject to collateralization rules, the amount of collateralization required for the account, the types of collateral that can be used as collateral for the account, any grace periods for under-collateralization, whether authorizations are required prior to collateralization changes, etc.

For example, for each account that is under-collateralized, the systems, methods, and computer program products of the present invention may determine whether proper documentation and signatures have been provided regarding the account or determine whether the account has been improperly listed as an account requiring collateralization. The systems, methods, and computer program products of the present invention may send correspondence to the manager for the account to indicate that either proper documentation is needed or that the account is classified incorrectly.

For under-collateralized accounts that are properly designated and documented, the systems, methods, and computer program products of the present invention may determine from the collateralization rules whether there is a grace period under which the account may remain under-collateralized for a time duration. For those accounts subject to grace periods, the systems, methods, and computer program products of the present invention determine whether the duration of under-collateralization is less than the grace period. For those under-collateralized accounts determined to be within the grace period associated with the account, the systems, methods, and computer program products of the present invention may not send these accounts for further collateralization but merely indicate that they are under-collateralized but within the grace period.

The systems, methods, and computer program products of the present invention may also analyze the types of collateral used as collateralization for an account and based on collateralization rules determine whether any of the collateral is not allowed for use with the account.

For under-collateralized accounts requiring added collateral and/or for accounts that are improperly collateralized with the wrong type of collateral, the systems, methods, and computer program products of the present invention may send information regarding such accounts to a custodial system for proper collateralization. In some embodiments, a basket of various assets of the institution may be provided to the custodial system for collateralizing accounts. Where an account is under-collateralized, the custodial system may pledge assets from the basket to the account that meet the collateralization type requirements associated with the account. Where an account is collateralized with the wrong type of collateral, the custodial system may place the improper collateral associated with the account in the basket and pledge proper collateral from the basket to properly collateralize the account.

In some embodiments, the basket of available assets may either not include enough assets of value to pledge to an account or not include a specific type of collateral needed to pledge to an account. In this instance, the systems, methods, and computer program products of the present invention may initiate a request to a trading system in the form of a trade blotter requesting that the trading system acquire assets to be pledged to an account.

In some embodiments, over-collateralized accounts may also be provided to a custodial system or other designated system for review. If no restrictions exist, collateral pledged to the account that is in excess to required collateralization amount for the account may be “unpledged” from the account and either placed in the basket or otherwise released back to the institution.

In addition to making adjustments to under- and over-collateralized accounts, the systems, methods, and computer program products of the present invention may also provide one or more user interfaces displaying the status of various accounts and allowing users to view and alter account information, as well as allow a user to selectively direct accounts to the custodial system for proper collateralization or place accounts on hold until proper paperwork is in order for the account prior to collateralization. The user interfaces may also allow users to track accounts, generate reports, etc.

More specifics regarding the systems, methods, and computer products of the present invention are described further below. Specifically, there are various parameters that determine the amount of collateral necessary for securing funds held in an account such as a public-deposit account. Some parameters relate to applicable state law requirements. Others relate to customer-specified requirements, such as pegs, minimums, and required margins. While still others relate to fluctuation in the deposit-account balance and/or fluctuation of the value of collateral pledged to the account. The present invention contemplates systems, methods, and computer program products for monitoring these parameters and identifying under- and over-collateralized positions within an institution's portfolio. For those identified positions, the present invention is capable of one or more of creating, submitting, and tracking pledge/release requests. For example, where the position is a bank account and the customer deposits additional funds, which results in an uninsured balance that exceeds the allocated collateral, the present invention identifies that account as being under-collateralized, determines whether the account is subject to under-collateralization rules, determines the pledge amount required to properly collateralize the account, and then creates, submits and tracks a pledge request that corresponds to the required pledge amount. Likewise, when a customer withdraws funds from a public-deposit account, which results in an uninsured balance that is less than the allocated collateral, the present invention may further identify that account as being over-collateralized, determine the appropriate release amount, and then create, submit and track a release request that corresponds to the determined release amount.

As further examples, the collateral pledged to a position may also fluctuate as the market value of the collateral changes. In instances, where the collateral pledged to a position decreases such that the position is under-collateralized, the present invention identifies that account as being under-collateralized, determines whether the account is subject to under-collateralization rules, determines the pledge amount required to properly collateralize the account, and then creates, submits and tracks a pledge request that corresponds to the required pledge amount. Where the collateral pledges increases in value such that the position is over-collateralized, the present invention may further identify that account as being over-collateralized, determine the appropriate release amount, and then create, submit and track a release request that corresponds to the determined release amount.

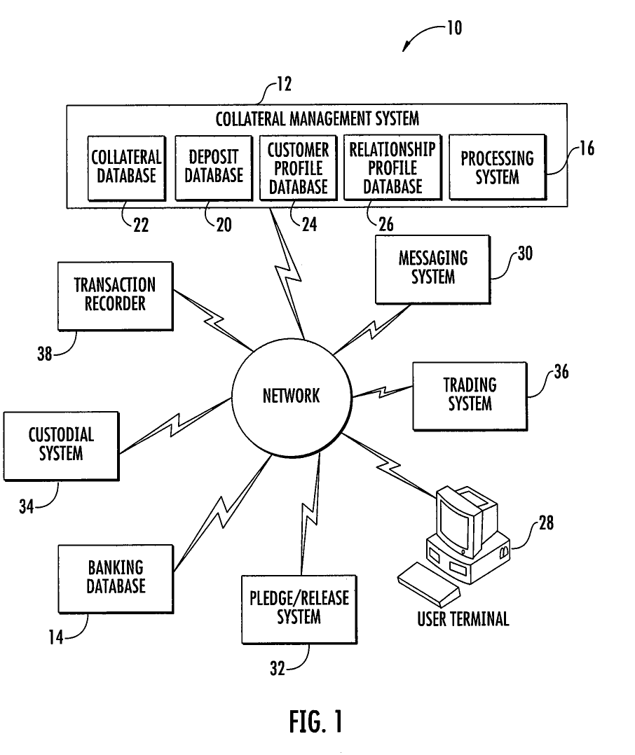

FIG. 1 illustrates a typical operational embodiment for the systems, methods, and computer program products of the present invention. In particular, embodiments of the present invention may be operated over a network, such as the Internet, to exchange information regarding collateralization between a user and a collateralization management system. As illustrated, a system 10 according to the present invention may include a collateralization management system 12 that identifies under- and over-collateralized public-deposit accounts held by a bank and, in response the present invention takes action to reconcile the identified accounts.

Note that herein the term “positions” is used to refer to any financial vehicle that requires collateralization. The term “account” and “public-deposit accounts” are types of positions. Further, note that herein the terms “deposit account” and “public-deposit account” are used broadly to refer to any type of deposit account, such as checking accounts, savings accounts, time deposit accounts, certificates of deposit, etc. The systems, methods, and computer program products are described below in relation to monitoring of collateralization of public fund deposit accounts. It is understood, however, that the systems, methods, and computer program products of the present invention may apply to any form of account where it is desirable to monitor collateralization.

The management system 12 includes a processing system 16 that monitors external sources 14 for information feeds that contain data relating to public-deposit accounts or other accounts requiring collateralization and directs said data to the deposit database 20 or the collateral database 22. In the exemplary embodiment, the processing system 16 extracts data from the external sources 14 at the beginning of each day. Because some information feeds may be incomplete, unavailable, or unchanged from the previous day, it will be appreciated that the processing system 16 can extract selected information feeds, instead of extracting all relevant information feeds.

The exemplary processing system 16 searches external sources 14 for information feeds containing positions requiring collateralization, such as public-deposit data and stores said information feeds in deposit database 20. It should be appreciated that data fields vary among the different types of deposit accounts. For example, some information feeds containing public-deposit data generally have the following data fields, but they may be in different order or in different formats: tax-Id, customer name, deposit account number, account class code, account legal designation, product type, issue date, maturity date, ledger balance, collected balance, accrued interest, interest rate, client relationship manager. The processing system 16 is capable of parsing data fields for various deposit accounts regardless of field formats and order of fields.

In addition to extracting information feeds containing public-deposit data or data from other accounts requiring collateralization from external sources 14, the processing system 16 extracts information feeds containing collateral data and stores said data in collateral database 22. Like deposit accounts, it should be appreciated that data fields vary among the different types of collateral records. For example, some information feeds containing collateral data generally have the following data fields, but they may be in different order or in different formats: portfolio IP, class code, pledge account number, relationship name, coupon, current par amount, original par amount, price, price date, market value amount, accrued interest, factor information, security description, rating, etc. The processing system 16 is capable of parsing data fields for various collateral data information feeds regardless of field formats and order of fields.

For purposes of this disclosure, a customer is the entity whose tax-ID is associated with a deposit account, and a relationship is a group of customers that share the same or substantially the same collateralization rules/requirements. For example, a relationship may consist of customers having deposits in the same state. When allocating collateral, it is may be possible to roll individual customers into a relationship, and allocate collateral to the group instead of each customer. For example, in some states, all public-deposit accounts for the state may be pooled for purposes of collateralization. This minimizes transactional costs associated with allocating collateral. The customer-profile database 24 contains information regarding customer attributes and the relationship-profile database 26 contains information regarding relationship attributes. Users, via a user terminal 30, input customer and relationship data into the customer-profile database 24 and the relationship-profile database 26, respectively. Customer attributes, for example, include the customer's name, address, contact person, tax-ID, deposit account numbers, peg amount, and minimum collateral amount. Relationship attributes may include the customer names and/or deposit-account numbers within the relationship. Relationship attributes also include rules for collateralizing the relationship. These rules are based on applicable state laws and customer requirements.

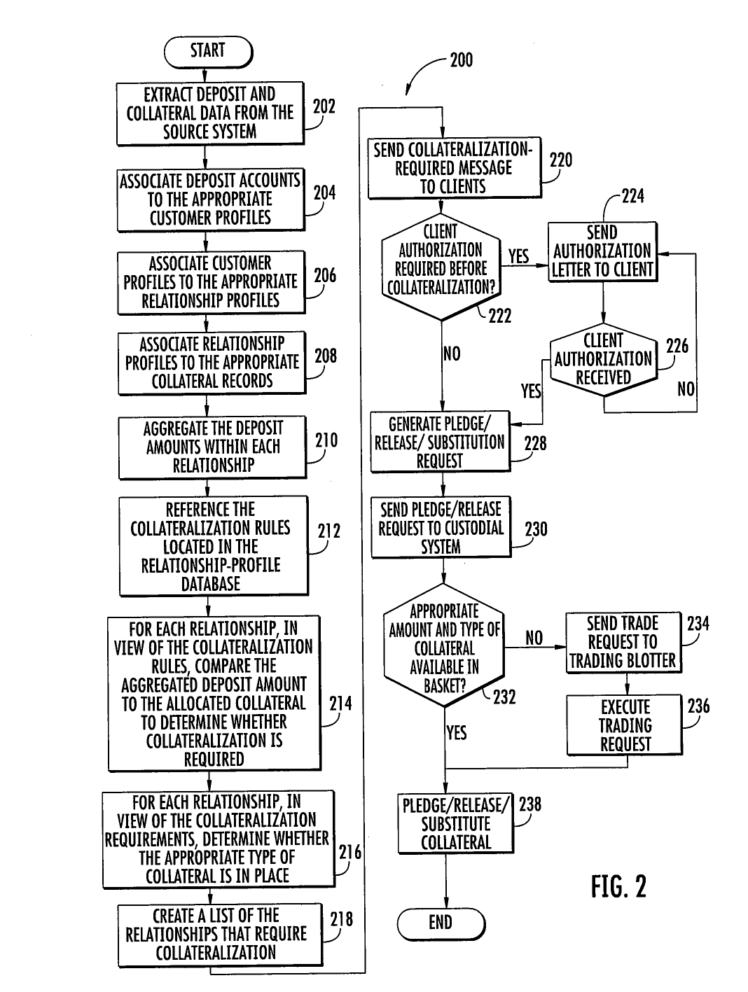

FIG. 2 is an illustrative embodiment of the systems, methods, and computer program products of the present invention. It is understood that FIG. 2 is only one illustration of the various ways in which the present invention may be implemented and is provided hereby as only one example. Referring now to FIG. 2, the processing system 16 executes various procedures 200 to determine whether relationships within the bank's portfolio are properly collateralized and facilitates collateral adjustments to those relationships that require collateralization. In step 202, the processing system 16 searches and extracts public-deposit data and public-collateral records from the deposit database 20 and the collateral database 22. Next, in step 204, the processing system 16 associates the public-deposit accounts with the appropriate customer profiles. In step 206, the processing system 16 associates the customer profiles with the appropriate relationship profiles. And, in step 208, the processing program associates the relationship profiles with the appropriate collateral records. Next, in step 210, the processing system 16 of this embodiment of the present invention aggregates the deposit amounts of the public-deposit accounts within each relationship profile, (In this example, the term relationship(s) is used to refer to either one account or a group of accounts that have been pooled together for collateralization, such as for example, where a plurality of accounts belonging to public fund depositors are pooled together for collateralization based on rules provided by the state.)

While not shown, the processing system may first analyze the accounts to determine whether they are properly listed as accounts requiring collateralization and/or whether proper documentation and authorizations regarding creation and set up of the account have been performed. For example, the processing system may determine whether an account manager improperly listed the account as a public funds account, such as by comparing the owner listed for the account to a list of known public fund clients. The processing system may also determine whether all appropriate paperwork has been submitted regarding the account. Any noted issues are sent to the account manager for review and action. Accounts noted with such problems may be suspended from further collateralization processing until such issues are resolved.

In step 212, the processing system next applies the collateralization rules associated with each relationship to determine whether action regarding collateralization is required. The collateralization rules, among other things, dictate whether a relationship is subject to collateralization rules, the amount of collateralization required (i.e., margin), types of assets that may be used for collateralization, any grace periods for under-collateralization, etc. The processing system references the collateralization rules located in the relationship-profile database 26, and in step 214, for each relationship, the processing system compares the aggregated deposit amount to the allocated collateral in view of the applicable collateral margin, which was obtained from the collateralization rules. If the collateral margin is not satisfied, then the program 200 instructs the processing system to flag the relationship as under-collateralized. Likewise, if the collateral margin is exceeded, then the relationship is flagged as over-collateralized.

Next, in step 216, for each relationship, the processing system determines whether the position is collateralized by the appropriate type of collateral, as specified by the collateralization rules stored in the relationship profile. If an inappropriate type of collateral is in place, the processing system flags the relationship as requiring collateral substitution.

In step 218, the processing system creates a list of relationships that require collateral adjustment. Multiple lists may be created. For example, the under-collateralized positions may be provided in one list, the over-collateralized positions in another list, and the positions collateralized by an inappropriate type of collateral in yet another list.

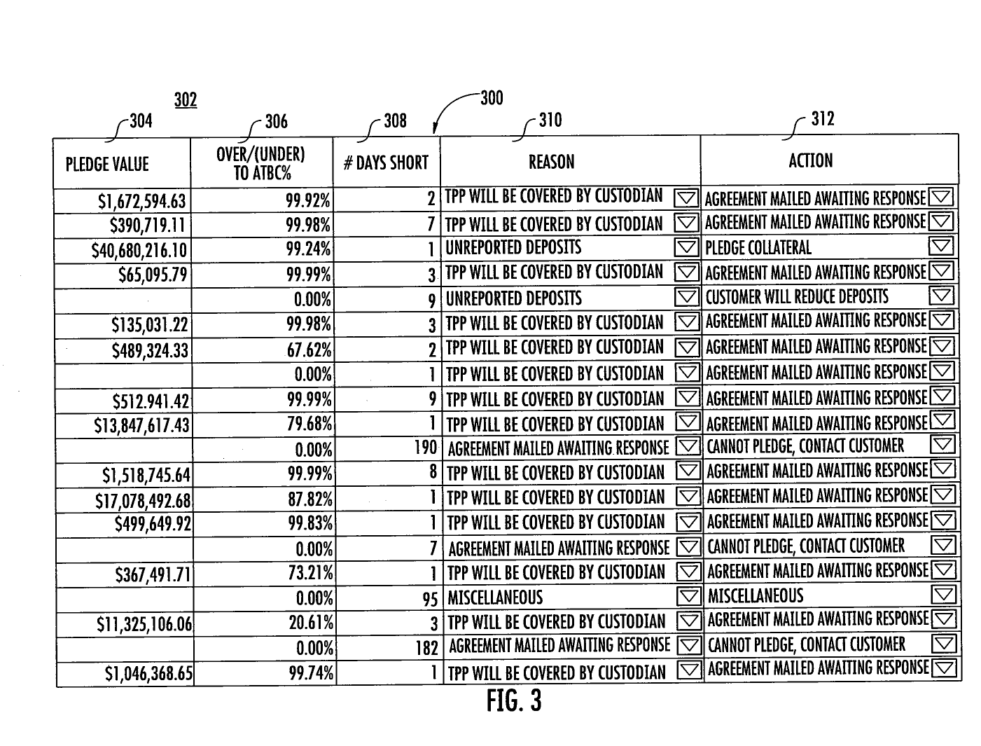

Referring now to FIG. 3, which illustrates an exemplary under-collateralization list 300 provided to a user via an interface 302 and displayed on the user terminal 28. The under-collateralized list 300 may provide the value of the pledge collateral 304, the amount to be collateralized 306, the number of days the position has been under collateralized 308, the reason for the under-collateralization 310, and available actions that may be taken to collateralize the position 312. A variety of reasons exist for the under-collateralization. For example, the customer may have made deposits or added a new deposit account within the relationship without notifying the collateral management, the market value of the collateral may have decreased, the client has not authorized the collateralization, or the under-collateralized position is within the grace period provided in the relationship profile. Once the user or system has identified the applicable reason for an under-collateralized position, the user or system selects such reason from the drop-down menu provided by the interface 302.

Referring again to FIG. 2, in step 220, the processing system 16 may instruct the message system 30 to generate and send a message to clients associated with the relationships that require collateral adjustment. For under-collateralized positions, the message may indicate the information displayed by the user interface 302. For over-collateralized positions, the message may indicate the pledged collateral, the amount by which the position is over-collateralized, the number of days the position has been over-collateralized, the reason for the over-collateralization, and available actions that may be taken to reconcile the position. And, for positions collateralized with an inappropriate type of collateral, the message may indicate the type of collateral currently pledged and the available and appropriate types of collateral that may be substituted.

After generating and sending messages, in step 222, the processing system references the relationship-profile database 26 to determine which relationships require client authorization before collateralizing. In step 224, the processing system sends authorization requests to clients that require authorization, and, in step 226, the processing system may await authorization before proceeding.

In step 228, the process system 16 instructs the pledge/release system 32 to generate a pledge request for each of the under-collateralized positions, a release request for each of the over-collateralized positions, and a substitution request for positions that are collateralized by an inappropriate type of collateral. It should be appreciated that other actions are available in step 228. For example, an acceptable action may be “no action” because the position is still within the prescribed grace period. It should also be appreciated that a user can manually direct the processing system 16 as to which action to take. For example, with reference to FIG. 3, the interface 302 may provide a drop-down menu, which provides a variety of actions from which a user may select. For example, the user may select from among the following: “No action, within grace period”, “Cannot Pledge, contact customer”, “Miscellaneous”, “Adjustment will be made by custodial system”, “Pledge Collateral”, “Release Collateral”, or “Substitute Collateral”.

In step 230, the processing system 16 sends the pledge/release/substitution requests to a custodial system 34, and, in step 232, the custodial system 34 determines whether the “basket” of possible collateral for the relationship includes sufficient collateral or the type of collateral needed to execute the pledge/release/substitute request. If the “basket” does not include the appropriate collateral, the custodial system, in step 234, sends the request to the trading system 36. For example, the request to the trading system 36 may be a trading blotter containing the following data fields: trade date, relationship name, status, pledge account number, security type, pledge/release/submit, CUSIP, amount, par/mkt value, par/mkt indicator, 30-day notification days open, status, days open, or notes.

Upon receiving the request, the trading system 36, in step 236, submits the trade and then provides status updates regarding custodian and customer confirmation. Then, after receiving custodian and customer confirmations, the trading system 36 releases the trade ticket and provides status updates regarding the pending settlement. For example, the trading system 36 indicates whether the trade settled or failed. If the trade settles and the appropriate collateral is acquired, the trading system 36 then allocates the acquired collateral to the “basket”. If the trade failed, the trading system will continue to search for proper collateral to be purchased to meet the under collateralization of the account.

Once the appropriate collateral is available in the “basket”, the custodial system 34 adjusts the collateral position for the relationship by pledging appropriate collateral from the basket to the relationship, step 238. In this manner, the account or accounts associated with the relationship is properly collateralized in compliance with the collateralization rules associated with the account, such that the financial institution maintains compliance regarding collateralization of accounts.

It should be appreciated that a transaction recorder 38 is provided for recording the actions taken by the collateral management system. These records are then indexed so as to enable users to analyze the transaction data to determine whether the collateral management system 12 is efficiently allocated collateral. For example, using the historical data stored in the transaction recorder 38, the system may generate information tables that present information about items that are over-collateralized, how long they have been over-collateralized, and by how much they have been over-collateralized. This information apprises management as to whether the bank's collateral is being used efficiently.

The present invention can be implemented as a method, as a system, as computer instruction codes, as an apparatus and/or combinations of any of the above. Some of the claims of the application may be drafted in means-plus-function format. While the means recited in these claims can be implemented by any number of systems, devices, computer program code, etc., provided below are examples of structural systems that may meet the functions outlined by the recited means.

For example, the means for analyzing accounts, determining which accounts require collateralization, collateralizing accounts, and reporting information regarding accounts, etc., can be implemented as a processor or general computing element that uses software code instructions to perform these functions. The processor could, as an alternative, be an application specific IC chip that it hard-wired to perform the stated functions. The various means could also be met by a distributed network of processing elements that perform various portions of the recited functions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for collateralizing a position comprising:
a processing system capable of analyzing data associated with the position to determine whether the position is at least one of over- or under-collateralized; and
a pledge/release system in communication with the processing system and configured to generate at least one of a pledge or release request if the position is not properly collateralized.

2. The system of claim 1, wherein the position is a group of public-deposit accounts and said processing system analyzes the public-deposit account to determine whether the position is at least one of over- or under-collateralized.

3. The system of claim 1, wherein the processing system is configured to determine the amount by which the position is at least one of over- or under-collateralized and generate at least one of a pledge or release request based on the amount by which the position is either over- or under-collateralized.

4. The system of claim 3 further comprising:
a messaging system configured to send a message to a client associated with the position, wherein the message indicates the amount by which the position is at least one of over- or under-collateralized.

5. The system of claim 3 further comprising:
a messaging system configured to generate a display displaying on one or more positions and providing information regarding current collateralization of each position.

6. The system of claim 3, wherein the pledge/release system sends at least one of a pledge or release request to a trading system, and wherein said trading system pledges/releases collateral from or to a basket of collateral.

7. The system of claim 3, wherein the pledge/release system sends at least one of a pledge or release request to a trading system, wherein said trading system acquires collateral sufficient to collateralize the position.

8. The system of claim 7, wherein the pledge/release system further sends information regarding a type of collateral needed to collateralize the position, and said trading system acquires collateral based on said requirement.

9. The system of claim 1, wherein at least one of the positions is collateralized based on a set of rules, and wherein said processing system is capable of analyzing data associated with the position relative to a set of rules associated with the position to determine whether the position is at least one of over- or under-collateralized.

10. The system of claim 9, wherein a rule associated with a position allows a grace period in which the fund may remain under-collateralized, and wherein said processing system determines a time for which the position has been under-collateralized and compares said time to the grace period associated with the position.

11. A method for collateralizing a position comprising:
analyzing data associated with the position to determine whether the position is at least one of over- or under-collateralized; and
generating at least one of a pledge or release request if the position is not properly collateralized.

12. The method of claim 11, wherein the position is a group of public-deposit accounts and said analyzing data associated with the position comprises analyzing the public-deposit account to determine whether the position is at least one of over- or under-collateralized.

13. The method of claim 11 further comprising:
determining the amount by which the position is at least one of over- or under-collateralized, and
generating at least one of a pledge or release request based on the amount by which the position is either over- or under-collateralized.

14. The method of claim 13 further comprising:
sending a message to a client associated with the position, wherein the message indicates the amount by which the position is at least one of over- or under-collateralized.

15. The method of claim 13 further comprising:
displaying on one or more positions and providing information regarding current collateralization of each position.

16. The method of claim 13 further comprising pledging or releasing collateral from an escrow based on the pledge or release request.

17. The method of claim 13 further comprising acquiring collateral sufficient to collateralize the position based on the at least one of a pledge or release request.

18. The method of claim 13 further comprising acquiring collateral sufficient to collateralize the position based on the at least one of a pledge or release request based on a type of collateral specified in the at least one of a pledge or release request needed to collateralize the position.

19. The method of claim 11, wherein at least one of the positions is collateralized based on a set of rules, and wherein said method further comprises analyzing data associated with the position relative to a set of rules associated with the position to determine whether the position is at least one of over- or under-collateralized.

20. The method of claim 19, wherein a rule associated with a position allows a grace period in which the fund may remain under-collateralized, and wherein said method further comprises determining a time for which the position has been under-collateralized and compares said time to the grace period associated with the position.

21. A computer program product for collateralizing a position, the computer program product including a computer-readable medium having computer program code embodied therein, the computer program code comprising:
instructions for analyzing data associated with the position to determine whether the position is at least one of over- or under-collateralized; and
instructions for generating at least one of a pledge or release request if the position is not properly collateralized.

22. The computer program product of claim 21, wherein the position is a group of public-deposit accounts and said instructions for analyzing data associated with the position analyzes the public-deposit account to determine whether the position is at least one of over- or under-collateralized.

23. The computer program product of claim 21 further comprising:
instructions for determining the amount by which the position is at least one of over- or under-collateralized, and
instructions for generating at least one of a pledge or release request based on the amount by which the position is either over- or under-collateralized.

24. The computer program product of claim 23 further comprising:
instructions for sending a message to a client associated with the position, wherein the message indicates the amount by which the position is at least one of over- or under-collateralized.

25. The computer program product of claim 23 further comprising:
instruction for displaying on one or more positions and providing information regarding current collateralization of each position.

26. The computer program product of claim 23 further comprising instructions for pledging or releasing collateral from an escrow based on the pledge or release request.

27. The computer program product of claim 23 further comprising instructions for acquiring collateral sufficient to collateralize the position based on the at least one of a pledge or release request.

28. The computer program product of claim 23 further comprising instructions for acquiring collateral sufficient to collateralize the position based on the at least one of a pledge or release request based on a type of collateral specified in the at least one of a pledge or release request needed to collateralize the position.

29. The computer program product of claim 21, wherein at least one of the positions is collateralized based on a set of rules, and wherein said computer program product further comprises instructions for analyzing data associated with the position relative to a set of rules associated with the position to determine whether the position is at least one of over- or under-collateralized.

30. The computer program product of claim 21, wherein a rule associated with a position allows a grace period in which the fund may remain under-collateralized, and wherein said computer program product further comprises instructions for determining a time for which the position has been under-collateralized and instructions for comparing said time to the grace period associated with the position.

31. A system for collateralizing a position comprising:
a processing system capable of analyzing data associated with the position to determine whether the position is at least one of over- or under-collateralized;
a pledge/release system in communication with the processing system and configured to generate a pledge request if the position is not properly collateralized; and
a trading system in communication with said pledge/release system, wherein said trading system acquires collateral needed to pledge to an under-collateralized account.

32. The system of claim 31, wherein the pledge/release system sends a pledge request to a trading system, and wherein said trading system pledges collateral to a basket of collateral.

33. The system of claim 31, wherein the pledge/release system further sends information regarding a type of collateral needed to collateralize the position, and said trading system acquires collateral based on said requirement.

34. A method for collateralizing a position comprising:
analyzing data associated with the position to determine whether the position is at least one of over- or under-collateralized;
generating at least one of a pledge or release request if the position is not properly collateralized; and
acquiring collateral needed to pledge to an under-collateralized account.

35. The method of claim 34, wherein acquiring collateral needed to pledge to an under-collateralized account comprises pledging collateral to a basket of collateral.

36. The method of claim 34, wherein said generating at least one of a pledge or release request if the position is not properly collateralized further sends information regarding a type of collateral needed to collateralize the position, and said acquiring collateral needed to pledge to an under-collateralized account acquires collateral based on said requirement.

37. A computer program product for collateralizing a position, the computer program product including a computer-readable medium having computer program code embodied therein, the computer program code comprising:
instructions for analyzing data associated with the position to determine whether the position is at least one of over- or under-collateralized;
instructions for generating at least one of a pledge or release request if the position is not properly collateralized; and
instructions for acquiring collateral needed to pledge to an under-collateralized account.

38. The computer program product of claim 37, wherein said instructions for acquiring collateral needed to pledge to an under-collateralized account comprises instructions for pledging collateral to a basket of collateral.

39. The computer program product of claim 37, wherein said instructions for generating at least one of a pledge or release request if the position is not properly collateralized further comprises instructions for sending information regarding a type of collateral needed to collateralize the position, and said instructions for acquiring collateral needed to pledge to an under-collateralized account acquires collateral based on said requirement.
